(19) United States
(12) Patent Application Publication
(10) Pub. No.: US 2005/0158092 A1
(43) Pub. Date: Jul. 21, 2005

(54) Business machine

(75) Inventor: Tsung-Te Lin, Taipei (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/039,254

(22) Filed: Jan. 19, 2005

(30) Foreign Application Priority Data
Jan. 19, 2004 (TW) TW93200977

(51) Int. Cl. G03G 15/00; A47B 96/04

(52) U.S. Cl. 399/380

(57) ABSTRACT

A business machine. The business machine includes a cover, a main body and a flexible element connecting the main body and a lateral side of the cover. When the cover moves with respect to the main body, the flexible element is bent around an axis substantially parallel to the lateral side of the cover.

### BACKGROUND OF THE INVENTION

1. Field of the Invention

The present invention relates in general to a business machine and in particular to a business machine capable of scanning different objects of various thicknesses.

2. Description of the Related Art

A conventional business machine, such as a scanner, generally comprises a main body and a cover with an object placed therebetween for scanning. Referring to FIG. 1a, the conventional business machine has a main body 10 and a cover 20 detachably connected thereto. The cover 20 has a protrusion 21 and the main body 10 has a slot 11 for receiving the protrusion 21. When scanning, an object is positioned between the cover 20 and the main body 10 with the protrusion 21 appropriately inserted in the slot 11.

The cover 20, however, is easily separated from the main body 10. When scanning a thicker object, the protrusion 21 is particularly prone to separation, and is difficult to safely position in the slot 11. Moreover, as the depth of the slot 11 must be less than the height of the main body 10, it is not suitable for a business machine with a thin profile.

FIG. 1b illustrates another conventional business machine provided with a main body 30 and a cover assembly 40 having a cover C, a hinge 41 and a link 43. As shown in FIG. 1b, the cover assembly 40 and the main body 30 are pivotably joined by the hinge 42, wherein the cover C and the link 43 pivot by the hinge 41. An object T, such as a book, is placed between the main body 30 and the hinged cover assembly 40 thereon for scanning.

With respect to FIG. 1b, however, the link 43 occupies space and cannot be received in the main body 30. Furthermore, as the length of link 43 is fixed and may be too short to accommodate a thick object, it is poorly suited for scanning objects of various thicknesses.

### SUMMARY OF THE INVENTION

Accordingly, an object of the present invention is to provide a business machine capable of scanning different objects of various thicknesses. The business machine comprises a cover, a main body and a flexible element connecting the main body and a lateral side of the cover. When the cover moves with respect to the main body, the flexible element is bent around an axis substantially parallel to the lateral side of the cover.

### DESCRIPTION OF THE DRAWINGS

The present invention will become more fully understood from the detailed description given hereinbelow and the accompanying drawings, given by way of illustration only and thus not intended to be limitative of the present invention.

FIG. 1a is a perspective diagram of conventional business machine.

FIG. 1b is a perspective diagram of another conventional business machine;

FIG. 2a is a perspective diagram of the first embodiment in accordance with the present invention;

FIG. 2b is a side view of the X direction in FIG. 2a according to the present invention;

FIGS. 2c and 2d are perspective diagrams of the flexible element in accordance with the present invention;

FIG. 3a is a perspective diagram of the second embodiment in accordance with the present invention;

FIGS. 3b and 3c are perspective diagrams of the bendable sheet in accordance with the present invention; and

FIG. 4 is a perspective diagram of the third embodiment in accordance with the present invention.

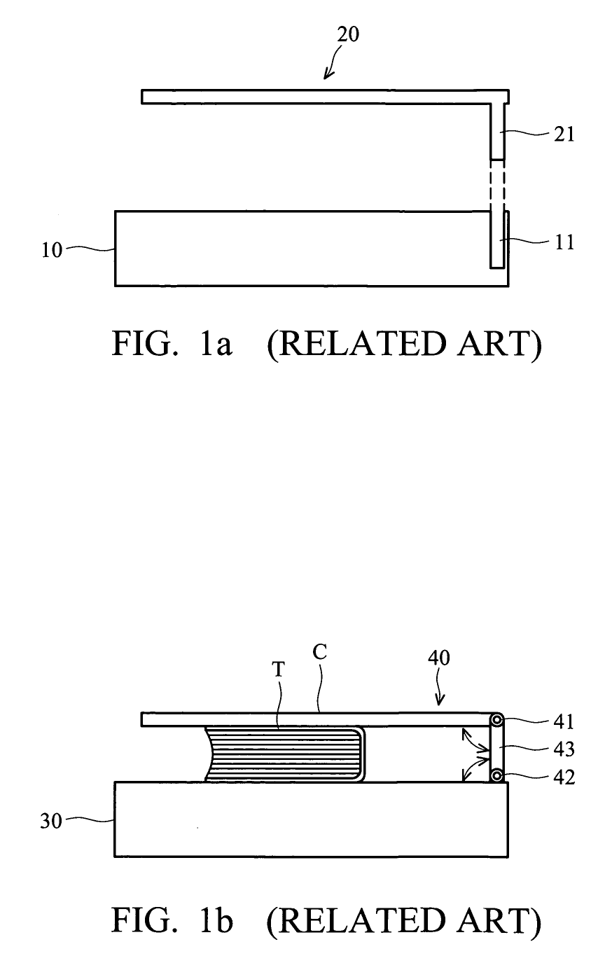

### DETAILED DESCRIPTION OF THE INVENTION

### First Embodiment

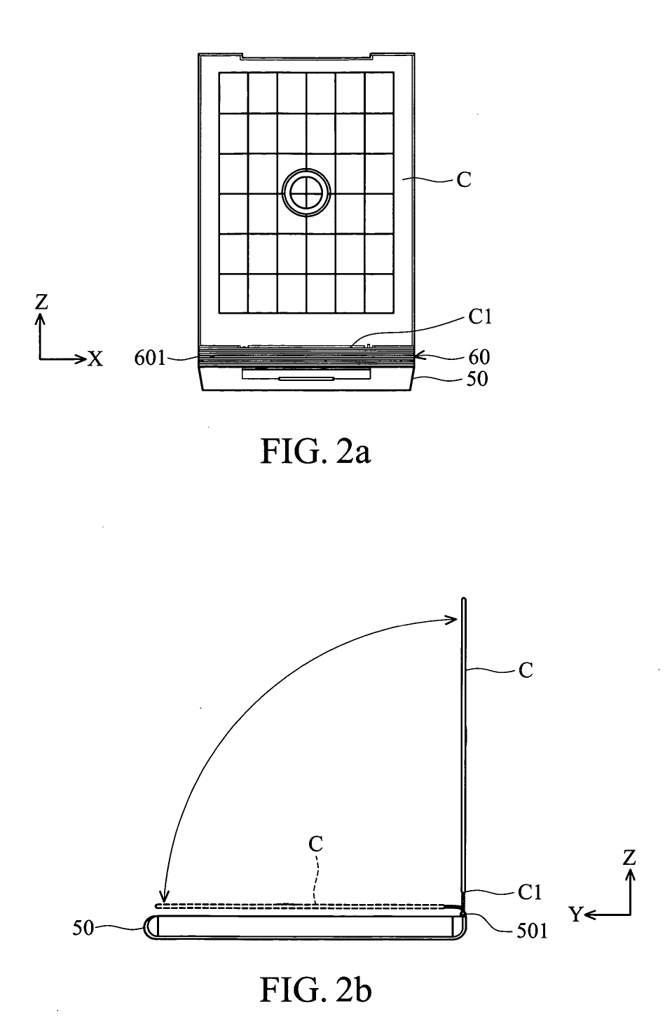

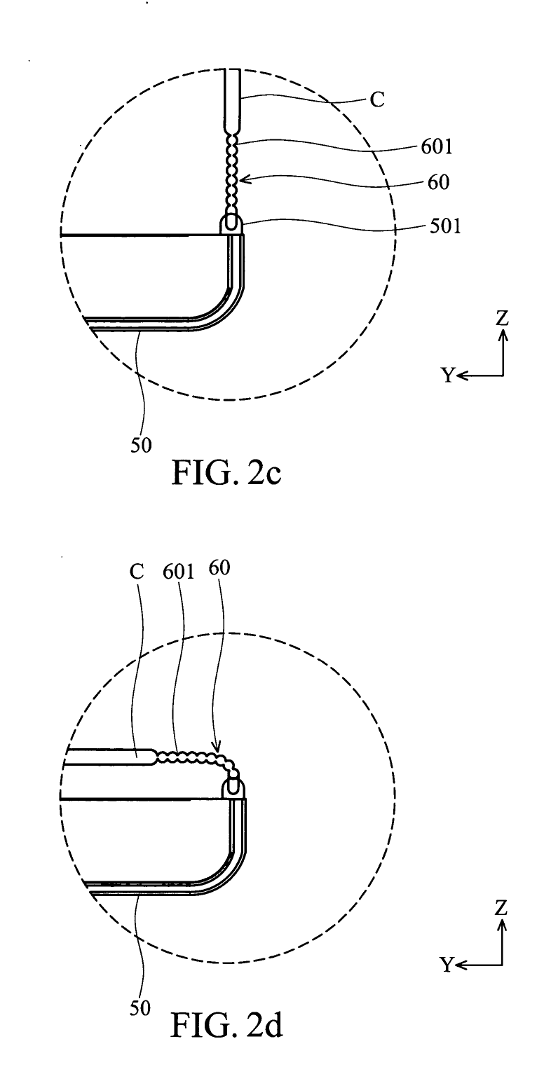

Referring to FIGS. 2a and 2b, the business machine, such as a scanner, comprises a main body 50, a cover C and a flexible element 60 connecting the main body 50 and a lateral side C1 of the cover C. In this embodiment, the flexible element 60 is plastic, however, it can also be rubber. Preferably, the flexible element 60 and the main body 50 can be integrally formed with low production cost. As shown in FIG. 2b, the cover C can alternatively rotate between a closed state (parallel to the Y axis) and an open state (erect and parallel to the Z axis) via the flexible element 60 as indicated by the arrows.

In FIG. 2a, the flexible element 60 has a plurality of depressed channels 601 parallel to the lateral side C1 in the X direction. As shown in FIGS. 2c and 2d, the main body 50 has a connecting portion 501 at the edge thereof connected to the flexible element 60 by adhesion, a conventional joining mechanism or screws.

To close the cover C from the state of FIG. 2c to FIG. 2d, the flexible element 60 is bent abound an axis parallel to the lateral side C1 (X direction) to cover an object for scanning. The channels 601 are provided parallel to the lateral side C1 (X direction) to facilitate the rotational stability of the cover C without tilting when bending the flexible element 60.

### Second Embodiment

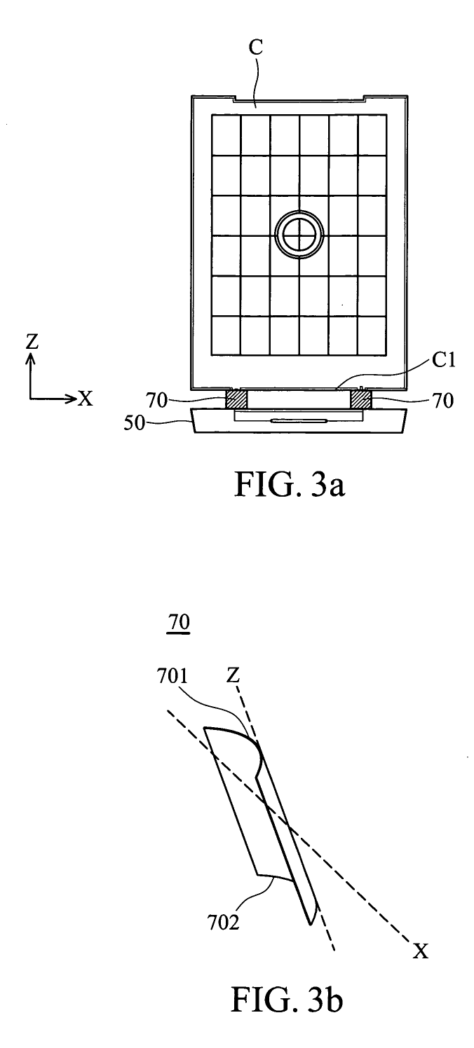

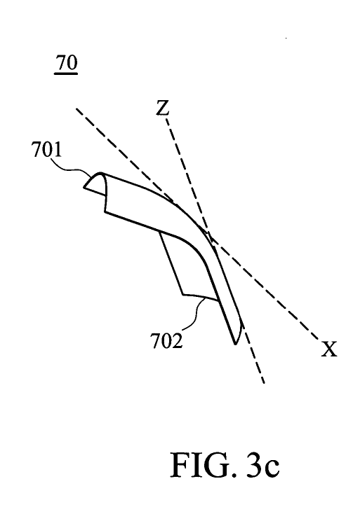

Referring to FIG. 3a, the above-mentioned flexible element 60 can be substituted for a bendable member such as a bendable sheet 70. As shown in FIG. 3a, the business machine, such as a scanner, comprises a main body 50, a cover C and two bendable sheets 70 connecting the main body 50 and a lateral side C1 of the cover C. In this embodiment, the flexible element 60 is a bendable steel sheet, however, it can also be plastic or rubber.

As shown in FIGS. 3b and 3c, the bendable sheet 70 is curved having a first curved portion 701 connecting the cover C and a second curved portion 702 connecting the main body 50. The cover C can rotate at an angle with respect to the main body 50 via the bendable sheet 70, wherein the bendable sheet 70 connects the main body 50 and the cover C by screws in this embodiment.

When the cover C is perpendicular to the main body 50 as shown in FIG. 3a, the bendable sheet 70 with curved structure can support and sustain the cover C. In FIG. 3b, the first and second curved portions 701 and 702 are parallel when the cover C is erect. As shown in FIG. 3c, when the cover C inclines with respect to the main body 50, the bendable sheet 70 is bent abound an axis parallel to the lateral side C1 (X direction) such that the cover C can cover the object for scanning.

According to this embodiment, a bendable steel sheet 70 is provided connecting the cover C and the main body 50. The bendable sheet 70 is capable of sustaining the cover C when erect, and facilitating rotation of the cover C between the open and closed states.

### Third Embodiment

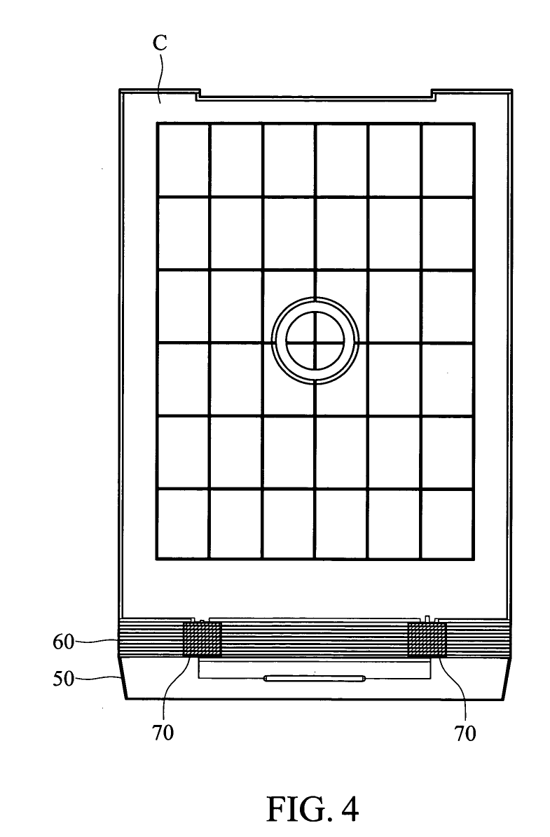

The first and second embodiments can be combined as shown in FIG. 4. The flexible element 60 with depressed channels and two bendable sheets 70 are disposed between the cover C and the main body 50, wherein the bendable sheets 70 separate the flexible element 60 into several segments. Thus, the cover C can be firmly sustained by the bendable sheets 70 when erect, and the flexible element 60 with depressed channels can also facilitate the rotational stability of the cover C. In summary, the present invention provides a business machine capable of scanning different objects of various thicknesses. The business machine has a simple structure and can reduce production cost and use space efficiently.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation to encompass all such modifications and similar arrangements.

1. A business machine, including:
a main body;
a cover having a lateral side; and
a flexible element connecting the main body and the lateral side, wherein the flexible element is bent around an axis substantially parallel to the lateral side of the cover when the cover moves with respect to the main body.

2. The business machine as claimed in claim 1, wherein the flexible element has a plurality of channels substantially parallel to the lateral side.

3. The business machine as claimed in claim 1, wherein the flexible element and the cover are integrally formed.

4. The business machine as claimed in claim 1, wherein the flexible element is rubber.

5. The business machine as claimed in claim 1, wherein the flexible element is plastic.

6. The business machine as claimed in claim 1, wherein the flexible element has a first curved portion connecting the lateral side and a second curved portion connecting the main body.

7. The business machine as claimed in claim 1, wherein the flexible element is curved and bent at an angle between the cover and the main body.

8. The business machine as claimed in claim 6, wherein the first curved portion and the second curved portions are substantially parallel when the cover is perpendicular to the main body.

9. The business machine as claimed in claim 6, wherein the flexible element is a bendable sheet.

10. The business machine as claimed in claim 9, wherein the bendable sheet is steel.

11. The business machine as claimed in claim 9, wherein the bendable sheet is plastic.

12. The business machine as claimed in claim 1 further including a bendable sheet having a first curved portion connecting the lateral side and a second curved portion connecting the main body.

13. The business machine as claimed in claim 12, wherein the first and second curved portions are substantially parallel when the cover is perpendicular to the main body.
